(19) United States
(12) Patent Application Publication
(10) Pub. No.: US 2017/0274557 A1
(43) Pub. Date: Sep. 28, 2017

(54) Method for Controlling a Wall Saw System When Making a Separating Cut

(71) Applicant: HILTI AKTIENGESELLSCHAFT, Schaan (LI)

(72) Inventors: Wilfried KANEIDER, Rankweil (AT); Dragan STEVIC, Feldkirch-Tosters (AT); Christian BEREUTER, Lingenau (AT); Peter HRICKO, Buchs (CH)

(73) Assignee: Hilti Aktiengesellschaft, Schaan (LI)

(21) Appl. No.: 15/509,453

(22) PCT Filed: Sep. 1, 2015
(86) PCT No.: PCT/EP2015/069949

§ 371 Date: Mar. 7, 2017

(30) Foreign Application Priority Data
Sep. 8, 2014 (EP) 14003097.4

(51) Int. Cl. B28D 1/04; B28D 7/00; B23D 59/00

(52) U.S. Cl. CPC B28D 1/042; B23D 59/001; B28D 7/005; B28D 1/04

(57) ABSTRACT

A method for controlling a wall saw system during the creation of a separating cut in a workpiece between a first and a second end point is disclosed. The separating cut is performed in a plurality of main cuts. The movement of the saw head is controlled at the end points such that a boundary of the wall saw facing the end point coincides with the end point after the pivoting movement of the saw arm into the main-cut angle of the following main cut. For a free end point, the boundary of the wall saw is formed by an upper exit point of the saw blade. For an obstacle, the boundary is formed by the saw blade edge of the saw blade if the processing occurs without the blade guard or by the blade guard edge of the blade guard if the processing occurs with the blade guard.

This application claims the priority of International Application No. PCT/EP2015/069949, filed Sep. 1, 2015, and European Patent Document No. 14003097.4, filed Sep. 8, 2014, the disclosures of which are expressly incorporated by reference herein.

### BACKGROUND AND SUMMARY OF THE INVENTION

The present invention relates to a method for controlling a wall saw system when making a separating cut.

A method is known from EP 1 693 173 B1 for controlling a wall saw system when making a separating cut in a workpiece between a first end point and a second end point. The wall saw system comprises a guide track and a wall saw with a saw head, a motorized feed unit that displaces the saw head parallel to a feed direction along the guide track, and at least one saw blade that is attached to a saw arm of the saw head and is driven about a rotation axis by a drive motor. The saw arm is pivotably designed by means of a pivot motor ad a pivot axis. By means of a pivot motion of the saw about the swivel axis, the penetration depth of the saw blade into the workpiece is changed. The motorized feed unit comprises a guide carriage and a feed motor, wherein the saw is attached to the guide carriage and is displaced via the feed motor along the guide track. To monitor the wall saw system, there is provided a sensor device with a pivot angle sensor and a displacement sensor. The pivot angle sensor measures the current pivot angle of the saw arm and the displacement sensor measures the current position of the saw head on the guide track. The measured values for the current pivot angle of the saw arm and the current position of the saw head are transmitted on a regular basis to a control unit of the wall saw.

The known method for controlling a wall saw system is subdivided into a preparatory part and a control unit-controlled processing of the separating cut. In the preparatory part, the user determines at least the saw blade diameter of the saw blade, the positions of the first and second end points in the feed direction, and the end depth of the separating cut; additional parameters may be the material of the workpiece to be worked on and the dimensions of the embedded rebar. From the input parameters, the control unit determines for the separating cut a suitable main cutting sequence of main cuts, wherein the main cutting sequence comprises at least a first main cut having a first main cutting angle of the saw arm and a first diameter of the utilized saw blade, as well as a subsequent second main cut having a second main cutting angle of the saw arm and a first diameter of the utilized saw blade.

After starting the controlled cutting, the saw head is positioned in a start position. In the start position, the saw arm is pivoted in a negative rotation direction about the pivot axis and arranged at the negative first main cutting angle. The saw head is moved in a positive feed direction along the guide track toward the second end point, wherein the saw arm during processing is in a pulling configuration. Prior to reaching the second end point, the saw head is stopped and is set back sufficiently far in a negative feed direction oriented opposite the positive feed direction. The saw arm is pivoted in a positive direction oriented opposite the negative rotation direction out of the negative first main cutting angle into a positive main cutting angle of the saw arm.

In a first variant, the saw arm is pivoted out of the negative first main cutting angle into the positive first main cutting angle and the saw head is moved in the positive feed direction to the second end point, wherein the saw arm is in a pushing configuration. Upon reaching the second end point, the feed direction is reversed and the saw head is moved in the negative feed direction to the first end point, wherein the saw arm is in a pulling configuration. Before reaching the first end point, the saw head is stopped and set back sufficiently far in the positive feed direction. The saw arm is pivoted out of the positive first main cutting angle into the negative first main cutting angle, and the saw head is moved in the negative feed direction to the first end point, wherein the saw arm is in a pushing configuration.

In a second variant, the saw arm is pivoted out of the negative first main cutting angle into the positive second main cutting angle, and the saw head is moved in the positive feed direction toward the second end point, wherein the saw arm is in a pushing configuration. Upon reaching the second end point, the feed direction is reversed and the saw head is moved in the negative feed direction toward the first end point, wherein the saw arm is in a pulling configuration.

Before reaching the first end point, the saw head is stopped and set back sufficiently far in the positive feed direction. The saw arm is pivoted out of the negative second main cutting angle into a positive main cutting angle, and the saw head is moved in the negative feed direction toward the first end point, wherein the saw arm is in a pushing configuration. If the second main cut represents the last main cut, the saw arm is pivoted into the positive second main cutting angle. If a third main cut having a third main cutting angle is performed, the saw arm is pivoted out of the negative second main cutting angle into the positive third main angle of the third main cut. The method steps are repeated until the end depth of the separating cut is reached.

The known method for controlling a wall saw system has the disadvantage that the saw head is set back prior to working in the pushing configuration of the saw arm. During such a setting-back, there is only a positioning of the saw head and no processing of the workpiece. The time required for positioning extends the non-productive times, especially for short cuts.

The object of the present invention consists of developing a method for controlling a wall saw system having a high level of cutting quality, in which the non-productive times for positioning the saw head and the saw arm are reduced.

In the method for controlling a wall saw system referred to in the beginning, this task is achieved according to the invention by the features of the independent claim. Advantageous developments are indicated in the dependent claims.

According to the invention, it is provided that the saw head is moved during the control unit-controlled cutting in such a manner that, after the pivot motion of the saw arm in the negative second main cutting angle, a second boundary of the wall saw, facing the second end point, coincides with the second end point, wherein the second boundary of the wall saw is formed by a second upper exit point, facing the second end point, of the utilized saw blade at a top side of the work piece when the second end point represents a free end point without obstacles, by a second saw blade edge facing the second end point of the utilized saw blade when the second end point represents an obstacle and the processing occurs without a blade guard, and by a second blade guard edge, facing the second end point, of the utilized blade guard when the second end point represents an obstacle and processing occurs with a blade guard.

The method according to the invention for controlling a wall saw system has the advantage that cutting with a saw arm arranged in a pulling and pushing manner is possible and non-productive times for positioning the saw head are reduced by a corresponding position controller of the saw head. A narrow cutting gap is achieved by the first main cut of the main cutting sequence basically occurring with a saw arm in a pulling configuration, and the saw blade being guided in the subsequent main cuts with a saw arm in a pushing configuration through the narrow cutting gap of the first main cut. A separating cut, in which the saw arm is configured alternatingly in a pulling and pushing manner, has the advantage that the non-productive times required to position the saw head and pivot the saw arm are reduced compared to cutting with a saw arm arranged exclusively in a pulling manner.

Preferably, prior to starting the control unit-controlled processing, a saw arm length of the saw arm, which is defined as the distance between the pivot axis of the saw arm and the rotation axis of the saw blade, and a distance between the pivot axis and the top side of the workpiece are defined. For the controlled processing of a separating cut, various parameters must be known to the control unit. These include the saw arm length that represents a fixed, device-specific dimension of the wall saw, and the perpendicular distance between the pivot axis and the surface of the workpiece that depends, besides the geometry of the wall saw, also on the geometry of the guide track used.

In a particularly preferred manner, prior to starting the controlled cutting, a first width for a blade guard utilized in the first main step and a second width for a blade guard utilized in the second main step are also established, wherein the first and second widths are composed of a first distance of the rotation axis to the first blade guard edge and a second distance of the rotation axis to the second blade guard edge. If an end point represents an obstacle, position controlling of the saw head occurs via the obstacle-facing blade guard edge of the blade guard used. For an asymmetric blade guard, the first and second distance of the rotation axis to the blade guard edges are different, whereas for a symmetrical blade guard, the first and second distance of the blade guard edges correspond to half the width of the blade guard.

The control method according to the invention is characterized by the fact that the second boundary of the wall saw, after the pivot movement of the saw arm into the negative second main cutting angle, coincides with the second end point. After the pivot motion of the saw arm into the negative second main cutting angle, the second upper exit point of the utilized saw blade coincides with the second end point when the pivot axis has a distance to the second end point of √[h₂·(D₂−h₂)]+δ·sin (−α₂), wherein h₂=h(−α₂, D₂)=D₂/2−Δ−δ·cos(−α₂) refers to the penetration depth of the utilized saw blade into the workpiece given a negative second main cutting angle with the second diameter, the second saw blade edge of the utilized saw blade coincides with the second end point when the pivot axis has a distance to the second end point of D₂/2+δ·sin((−α₂), and the second blade guard edge of the utilized blade guard coincides with the second end point when the pivot axis has a distance to the second end point of B_{2b}+δ·sin(−α₂).

In a first embodiment, the second main cut represents the last main cut of the main cutting sequence and the wall saw is moved into an end position after the second main cut.

The saw head is moved in a second main step in such a manner that a first boundary, facing the first end point, of the wall saw coincides with the first end point, wherein the first boundary of the wall saw is formed by a first upper exit point, facing the first end point, of the utilized saw blade on the top side of the workpiece when the first end point represents a free end point without an obstacle, by a first saw blade edge, facing the first end point, of the utilized saw blade when the first end point represents an obstacle and the processing occurs without blade guards, and by a first blade guard edge, facing the first end point, of the blade guard used when the first end point represents an obstacle and processing occurs with a blade guard.

The first upper exit point of the utilized saw blade coincides with the first end point when the pivot axis has a distance to the first end point of √[h₂·(D₂−h₂)]−δ·sin(−α₂), wherein h₂=h(−α₂, D₂)=D₂/2−Δ−δ−cos(−α₂) represents the penetration depth of the utilized saw blade into the workpiece given a negative second main cutting angle with the second diameter, the first saw blade edge of the utilized saw blade coincides with the first end point when the pivot axis has a distance to the first end point of D₂/2−δ·sin(−α₂), and the first blade guard edge of the utilized blade guard coincides with the first end point when the pivot axis has a distance to the first end point of B₂ₐ−δ·sin(−α₂).

In a second embodiment, the main cutting sequence has a third main cut, following the second main cut, with a third main cutting angle of the saw arm, a third diameter of the utilized saw blade, and a third width of the utilized blade guard with a first and second distance to the blade guard edges, wherein the saw arm is arranged in the third main step in a pulling configuration, and the saw head is moved in the positive feed direction.

In the second main cut, the saw head is moved with the saw tilted at the negative second main cutting angle in the negative feed direction toward the first end point. The saw is thereby moved during the control unit-controlled processing in such a manner that after the pivot motion of the saw arm in the negative third main cutting angle, the first boundary of the wall saw coincides with the first end point, wherein the first boundary is formed by the first upper exit point of the utilized saw blade when the first end point represents a free end point without an obstacle, by the first saw blade edge of the utilized saw blade when the first end point represents an obstacle and the processing occurs without a blade guard, and by the first blade guard edge of the utilized blade guard when the first end point represents an obstacle and the processing occurs with a blade guard.

The method according to the invention is characterized in that also the first boundary, facing the first end point, of the wall saw is used for control purposes. After the pivot motion of the saw arm in the third main cutting angle, the first boundary coincides with the first end point. In a particularly preferred manner, the first upper exit point of the utilized saw blade coincides with the first end point when the pivot axis has a distance to the first end point of √[h₃·(D₃−h₃)]δ·sin(−α₃), wherein h₃=h(−α₃, D₃)=D₃/2−Δ−δ·cos(−α₃) refers to the penetration depth of the utilized saw blade into the workpiece given a negative third main cutting angle with the third diameter, the first saw blade edge of the utilized saw blade coincides with the first end point when the pivot axis has a distance to the first end point of D₃/2−δ·sin(−α₃), and the first blade guard edge of the utilized blade guard coincides with the first end point, when the pivot axis has a distance to the first end point of B₃ₐ+δ·sin (−α₃).

The first and second main cuts are performed with a saw blade and a blade guard or alternatively, the first main cut is performed by a first saw blade and a first blade guard, wherein the first saw blade has a first saw blade diameter and the first blade guard has a first blade guard width, and the second main cut is performed by a second saw blade and a second blade guard, wherein the second saw blade has a second saw blade diameter and the second blade guard has a second blade guard width. The number of main cuts and the thereby utilized saw blade diameters depend, among other things, on the specification of the saw blade, the hardness of the material, the power and torque of the drive motor for the saw blade, as well as the end depth of the separating cut.

In a preferred embodiment, the first main cut of the main cutting sequence represents a precut and the saw head is positioned in a start position parallel to the feed direction after the control unit-controlled processing has started, wherein in the start position the first boundary, facing the first end point, of the wall saw coincides with the first end point after the pivot motion in the negative first main cutting angle, wherein the first boundary is formed by the first upper exit point of the utilized saw blade when the first end point represents a free end point without an obstacle, by the first saw blade edge of the utilized saw blade when the first end point represents an obstacle and the processing occurs without a blade guard, and by the first blade guard edge of the utilized blade guard when the first end point represents an obstacle and processing occurs with a blade guard.

In a particularly preferred manner, in the start position, the first upper exit point of the utilized saw blade coincides with the first end point when the pivot axis has a distance to the first end point of √[h₁·(D₁−h₁)]−δ·sin (−α₁), wherein h₁=h(−α₁, D₁)=D₁/2−Δ−δ·cos(−α₁) refers to the penetration depth of the utilized saw blade into the workpiece given a negative first main cutting angle with the first diameter, the first saw blade edge of the utilized saw blade coincides with the first end point when the pivot axis has a distance to the first end point of D₁/2−δ·sin(−α₁), and the first blade guard edge of the utilized blade guard coincides with the first end point, when the pivot axis has a distance to the first end point of B₁ₐ−δ·sin (−α₁).

In an alternative preferred embodiment, the main cutting sequence comprises a precut, performed prior to the first cut, having a zeroed main cutting angle of the saw arm, a zeroed diameter of the utilized saw blade, and a zeroed width of the utilized blade guard with a first and second distance to the blade guard edges, wherein during the precut the saw arm is arranged in a pulling configuration and the saw head is moved in the negative feed direction.

After starting the control unit-controlled cutting, the saw head is positioned in a start position parallel to the feed direction for the precut, wherein in the start position the second boundary, facing the second end point, of the wall saw coincides with the second end point after the pivot motion in the positive zeroed main cutting angle. In a particularly preferred manner, after the pivot motion of the saw arm to the positive zeroed main cutting angle, the second upper exit point of the utilized saw blade coincides with the second end point when the pivot axis has a distance to the second end point (E₂) of √[h₀·(D₀−h₀)]+δ·sin(+α₀), wherein h₀=h(+α₀, D₀)=D₀/2−Δ−67 ·cos(+α₀) refers to the penetration depth of the utilized saw blade into the workpiece given a positive zeroed main cutting angle with the zeroed diameter, the second saw blade edge of the utilized saw blade coincides with the second end point when the pivot axis has a distance to the first end point of D₀/2+δ·sin(+α₀), and the second blade guard edge of the utilized blade guard coincides with the second end point when the pivot axis has a distance to the second end point (E₂) of B_{0b}+δ·sin(+α₀).

The switch from precut (zeroed main cut) to the first main cut can be performed in various ways. The variants differ in how the residual material of the precut is removed. In a first variant, the precut is drawn through to the first end point and the material in the precut is completely removed. In a second variant, the saw arm is pivoted prior to reaching the first end point into the negative first main cutting angle and the residual material is completely or at least partially removed. A third variant abstains from the removal and pivots the saw arm directly from the positive zeroed pivot angle into the negative first main cutting angle.

In the first variant, in the controlled processing, the saw head is stopped in the feed direction when the first boundary of the wall saw coincides with the first end point, wherein the first boundary of the wall saw is formed by the first upper exit point of the utilized saw blade on the top side of the workpiece when the first end point represents a free end point without an obstacle, by the first saw blade edge of the utilized saw blade when the first end point represents an obstacle and cutting occurs without a blade guard, and by the first blade guard edge of the utilized blade guard when the first end point represents an obstacle and cutting occurs with a blade guard. The first variant is suited for a free end point particularly for large saw blade diameters and long guide tracks; for small saw blade diameters and short guide tracks, the end of the guide track may be reached before the first upper exit point coincides with the first end point.

Subsequently, the saw head is positioned in the positive feed direction in such a manner that the first boundary of the wall saw coincides with the first end point after the pivot motion of the saw arm in the negative first main cutting angle, wherein the first upper exit point coincides with the first end point when the pivot axis has a distance to the first end point of √[h₁−h₁)]+δ·sin (−α₁), wherein h₁=h(−α₁, D₁)=D₁/2−Δ−δ·cos(−α₁) refers to the penetration depth of the utilized saw blade into the workpiece given a negative first main cutting angle with the first diameter, the first saw blade edge of the utilized saw blade coincides with the first end point when the pivot axis has a distance to the first end point of D₁/2+δ·sin(−α₁), and the first blade guard edge of the utilized blade guard coincides with the first end point when the pivot axis has a distance to the first end point of B₁ₐ+δ·sin(−α₁).

In the second variant, the saw head is moved during the precut in the negative feed direction in such a manner that after the pivot motion of the saw arm in the negative zeroed main cutting angle, the first boundary of the wall saw coincides with the first end point, wherein the first upper exit point of the utilized saw blade coincides with the first end point when the pivot axis has a distance to the first end point of √[h₀·(D₀−h₀]−δ·sin (−α₀), wherein h₀=h(−α₀, D₀)=D₀/2−Δ−δ·cos(−α₀) refers to the penetration depth of the utilized saw blade into the workpiece given a negative zeroed main cutting angle with the zeroed diameter, the first saw blade edge of the utilized saw blade coincides with the first end point when the pivot axis has a distance to the first end point of D₀/2−δ·sin(−α₀), and the first blade guard edge of the utilized blade guard coincides with the first end point when the pivot axis has a distance to the first end point of B₀ₐ−δ·sin(−α₀).

In the second variant, the cutting of the precut occurs solely in a pulling manner and the saw arm is pivoted to the negative first main cutting angle before reaching the first end point. The second variant is used for a free end point, particularly for small saw blade diameters and short guide tracks, since the first variant can only be used to a limited degree for this configuration of saw blade diameters and track lengths. The pivoting of the saw arm increases the non-productive time for the separating cut.

After pivoting into the positive feed direction, the saw head is moved about a displacement length of at least 2δ·|sin(−α₀)| and the saw head is then positioned in such a manner that the first boundary of the wall saw, after the pivot motion of the saw arm into the negative first main cutting angle, coincides with the first end point, wherein the first upper exit point of the utilized saw blade coincides with the first end point when the pivot axis has a distance to the first end point of √[h₁·(D₁−h₁)]−δ·sin(−α₁), wherein h₁=h(−α₁, D₁)=D₁/2−Δ−δ·cos(−α₁) refers to the penetration depth of the utilized saw blade into the workpiece given a negative first main cutting angle with the first diameter, the first saw blade edge of the utilized saw blade coincides with the first end point when the pivot axis has a distance to the first end point of D₁/2−δ·sin(−α₁), and the first blade guard edge of the utilized blade guard coincides with the first end point when the pivot axis has a distance to the first end point of B₁ₐ−δ·sin(−α₁).

As an alternative for removal and positioning purposes, the saw head is moved in the positive feed direction in such a manner that the first boundary of the wall saw, after the pivot motion of the saw arm in the negative first main cutting angle, coincides with the first end point, wherein the first upper exit point of the utilized saw blade coincides with the first end point when the pivot axis has a distance to the first end point of √[h₁·(D₁−h₁)]−δ·sin(−α₁), wherein h₁=h(−α₁, D₁)=D₁/2−Δ−δ·cos(−α₁) refers to the penetration depth of the utilized saw blade into the workpiece given a negative first main cutting angle with the first diameter, the first saw blade edge of the utilized saw blade coincides with the first end point when the pivot axis has a distance to the first end point of D₁/2−δ·sin(−α₁), and the first blade guard edge of the utilized blade guard coincides with the first end point when the pivot axis has a distance to the first end point of B₁ₐ−δ·sin(−α₁).

In the third variant, the saw head is moved in the positive feed direction in such a manner that the first boundary of the wall saw, after the pivot motion of the saw arm in the negative first main cutting angle, coincides with the first end point, wherein the first upper exit point coincides with the first end point when the pivot axis has a distance to the first end point of √[h₁·(D₁−h₁)]−δ·sin(−α₁), wherein h₁=h(−α₁, D₁)=D₁/2−Δ−δ·cos(−α₁) refers to the penetration depth of the utilized saw blade into the workpiece given a negative first main cutting angle with the first diameter, the first saw blade edge of the utilized saw blade coincides with the first end point when the pivot axis has a distance to the first end point of D₁/2−δ·sin(−α₁), and the first blade guard edge of the utilized blade guard coincides with the first end point when the pivot axis has a distance to the first end point of B₁ₐ−δ·sin(−α₁).

The third variant fully abstains from removing the residual material in the precut. The distance is adjusted in such a manner that the first boundary of the wall saw, after the pivot motion of the saw arm in the negative first main cutting angle, coincides with the first end point. The variant without removing the residual material has the lowest non-productive times; however, a powerful drive motor, which can process the greater cutting depth at the end point, is required.

The method according to the invention applies to all main cuts in which the main cutting angle is smaller or equal to a critical pivot angle. The critical pivot angle corresponds to ±90° when the end point represents an obstacle and the critical pivot angle corresponds to 180°−arccos[Δ/(δ+D/2) when the end point represents a free end point without an obstacle.

Embodiments of the invention are described hereafter by means of drawings. These are not necessarily meant to depict the embodiments true to scale; rather, the drawings, where useful for explanation purposes, is executed in a schematic and/or slightly distorted form. In regard to supplements of the teachings directly evident from the drawings, one shall refer to the relevant prior art. In doing so, one shall take into account that diverse modifications and changes pertaining to the form and detail of an embodiment may be undertaken without deviating from the general idea of the invention. The features of the invention disclosed in the description, drawings, and claims may be significant individually as well as in any combination for developing the invention. In addition, falling within the scope of the invention are all combinations of at least two features disclosed in the description, drawings, and/or claims. The general idea of the invention is not restricted to the exact form or detail of the preferred embodiments shown and described below or limited to a subject matter that would be restricted in comparison to the subject matter claimed in the claims. For given dimensional ranges, values lying within the mentioned limits shall be disclosed as limits and they can be implemented and claimed as desired. For simplicity's sake, the same reference signs are used below for identical or similar parts or parts with identical or similar functions.

### BRIEF DESCRIPTION OF THE DRAWINGS

FIG. 1 illustrates a wall saw system with a guide track and a wall saw;

FIGS. 2A, B illustrates processing a separating cut between a first and second free end point without an obstacle;

FIGS. 3A, B illustrates processing a separating cut between a first and second obstacle with a saw blade that is not enclosed by a blade guard;

FIGS. 4A, B illustrates processing a separating cut between a first and second obstacle with a saw blade that is enclosed by a blade guard; and

FIGS. 5A-K illustrates the wall saw system of FIG. 1 when making a separating cut between a first obstacle and a second free end point without an obstacle.

### DETAILED DESCRIPTION OF THE DRAWINGS

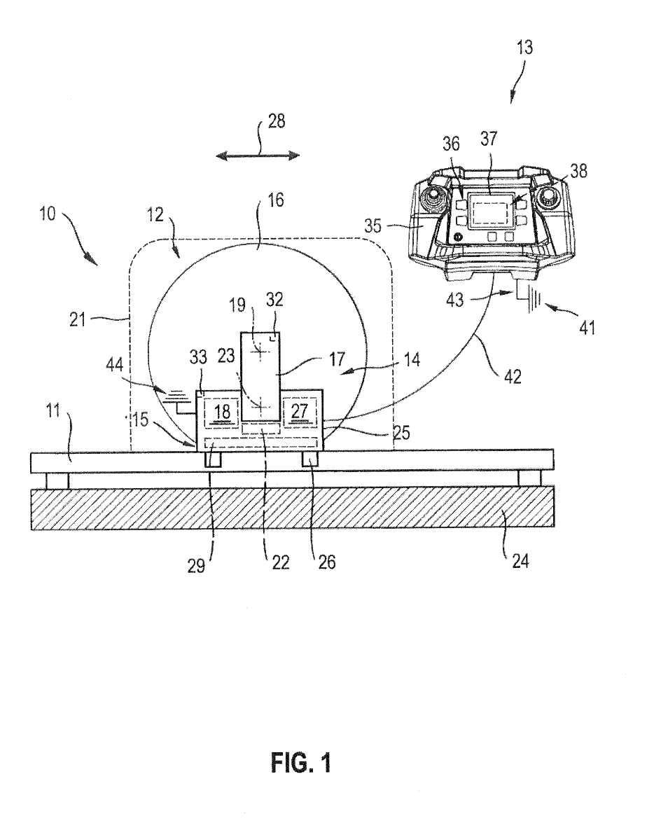

FIG. 1 depicts a wall saw system 10 with a guide track 11, a tool device 12 displaceably arranged on guide track 11, and a remote control unit 13. The tool device is designed as a wall saw 12 and comprises a cutting unit 14 and a motorized feed unit 15. The cutting unit is designed as a saw head 14 and comprises a cutting tool 16 designed as a saw blade, which is attached to a saw arm 17 and is driven by a drive motor 18 about a rotation axis 19.

To protect the operator, saw blade 16 is enclosed by a blade guard 21, which is attached to saw arm 17. Saw arm 17 is designed to be pivotable by a pivot motor 22 about a pivot axis 23. Pivot angle α of saw arm 17 along with a saw blade diameter D of saw blade 16 determines how deep saw blade 16 penetrates into a workpiece 24 to be cut. Drive motor 18 and pivot motor 22 are arranged in a device housing 25. Motorized feed unit 15 comprises a guide carriage 26 and a feed motor 27, which in the embodiment is also arranged in device housing 25. Saw head 14 is attached on guide carriage 26 and is designed to be displaceable via feed motor 27 along guide track 11 in a feed direction 28. Arranged in device housing 25 are, besides motors 19, 22, 27, a control unit 29 for controlling saw head 14 and motorized feed unit 15.

To monitor wall saw system 10 and the cutting process, a sensor device having multiple sensor elements is provided. A first sensor element 32 is designed as a pivot angle sensor and a second sensor element 33 is designed as a displacement sensor. Pivot angle sensor 32 measures the current pivot angle of saw arm 17 and displacement sensor 33 measures the current position of saw head 14 on guide track 11. The measurement variables are transmitted by pivot angle sensor 32 and displacement sensor 33 to control unit 29 and are used to control wall saw 12.

Remote control 13 comprises a device housing 35, an input device 36, a display device 37, and a control unit 38, which is arranged inside device housing 35. Control unit 38 converts the inputs of input device 36 into control commands and data, which are transmitted via a first communications link to wall saw 12. The first communications link is designed as a wire- and cable-less communications link 41 or as communications cable 42. The wire- and cable-less communications link is designed in the embodiment as radio link 41, which is formed between a first radio unit 43 on remote control unit 13 and a second radio unit 44 on tool device 12. Alternatively, the wire- and cable-less communications link 41 may be designed in the form of an infrared, Bluetooth, WLAN, or WiFi link.

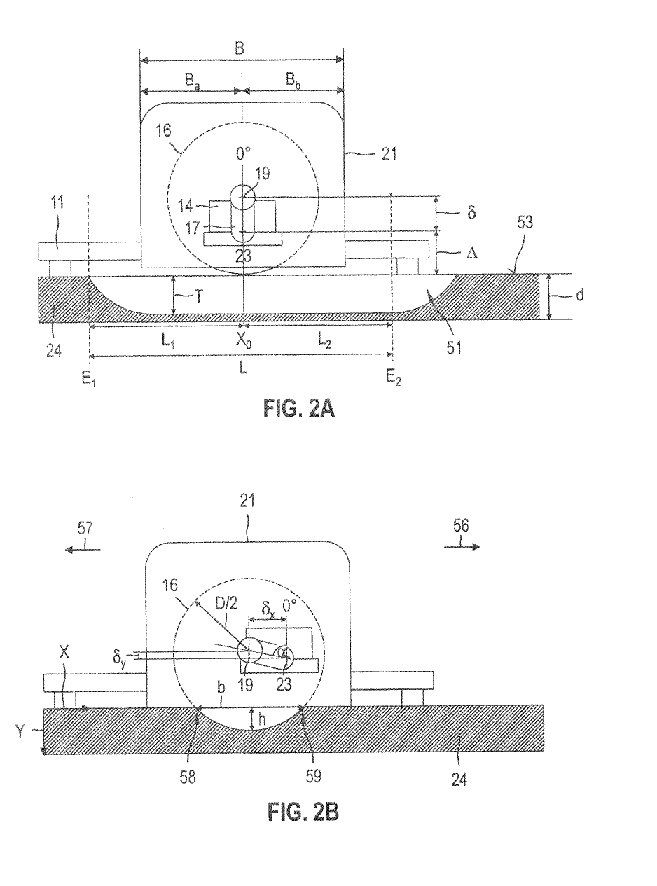

FIGS. 2A, B depict guide track 11 and wall saw 12 of wall system 10 of FIG. 1 when making a separating cut 51 in workpiece 24 having workpiece thickness d. Separating cut 51 has an end depth T and moves in feed direction 28 between a first end point E₁ and a second end point E₂. A direction parallel to feed direction 28 is defined as direction X, wherein positive direction X is oriented from first end point E₁ to second end point E₂, and a direction perpendicular to direction X into the depth of workpiece 24 is defined as direction Y.

The end point of a separating cut may be defined as a free end point without an obstacle or as an obstacle. Both end points can thereby be defined as free end points without obstacles, both end points as obstacles, or an end point as a free end point and the other end point as an obstacle. An overcut may be permitted at a free end point without an obstacle. By means of the overcut, the cutting depth at the end point reaches end depth T of the separating cut. In the embodiments of FIGS. 2A, B, end points E₁, E₂ form free end points without obstacles, wherein overcutting is not permitted at the free first end point end point E₁, and overcutting does occur at second end point E₂.

FIG. 2A depicts saw head 14 in an installation position X₀ and saw arm 17 in a basic position of 0°. Saw head 14 is positioned by the operator, by means of guide carriage 26, in installation position X₀ on guide track 11. Installation position X₀ of saw head 14 lies between first and second end points E₁, E₂ and is determined by the position of pivot axis 23 in feed direction 28. The position of pivot axis 23 is particularly suited as a reference position X_{Ref} to monitor the position of saw head 14 and control wall saw 12, since the X-position of pivot axis 23 remains unchanged even during the pivot motion of saw arm 17. Alternatively, a different X-position can be established as a reference position on saw head 14, wherein the distance in direction X to pivot axis 23 must be known in this case.

In the embodiment, the X-positions of first and second end points E₁, E₂ are established by entering partial lengths. The distance between installation position X₀ and first end point E₁ are determined by a first partial length L₁and the distance between installation position X₀ and second end point E₂ are determined by a second partial length L₂. Alternatively, the X-positions of end points E₁, E₂ may be established by entering a partial length (L₁ or L₂) and a total length L as a distance between end points E₁, E₂.

Separating cut 51 is made in multiple partial cuts until the desired end depth T is reached. The partial cuts between the first and second end points E₁, E₂ are defined as main cuts and the cutting sequence of the main cuts is defined as the main cutting sequence. At the end points of the separating cut, one can perform additional corner-cutting that is referred to as obstacle cutting for an obstacle, and overcut cutting for a free end point with overcutting.

The main cutting sequence can be established by the operator or the main cutting sequence can be established by the control unit of the wall saw system as a function of multiple boundary conditions. Conventionally, the first main cut, which is also referred to as a precut, is carried out with a reduced cutting depth and reduced power of the drive motor to prevent the saw blade from becoming polished. The additional main cuts are generally performed with the same cutting depth, but they may also have various cutting depths. The boundary conditions typically established by an operator include the cutting depth of the precut, the efficiency of the precut, and the maximum cutting depth of the additional main cuts. From these boundary conditions, the control unit can determine the main cutting sequence.

The main cuts of a separating cut are performed with one saw blade diameter or with two or more saw blade diameters. If multiple saw blades are used, the cutting generally begins with the smallest saw blade diameter. To be able to assemble saw blade 16 on saw arm 17, saw blade 16 must be arranged in the basic position of saw arm 17 above workpiece 24. Whether this boundary condition is met depends on two device-specific variables of wall saw system 10: on the one hand, a perpendicular distance A between pivot axis 23 of saw arm 17 and on the other, a top side 53 of workpiece 24 and a saw arm length δ of saw arm 17, which is defined as the distance between rotation axis 19 of saw blade 16 and pivot axis 23 of saw 17. When the sum of these two device-specific variables is greater than half the saw blade diameter D/2, saw blade 16 is arranged in the basic position above workpiece 24. Saw blade length δ is a fixed device-specific variable of wall saw 12, whereas perpendicular distance Δ between pivot axis 23 and surface 53 depends, besides on the geometry of wall saw 12, also on the geometry of utilized guide track 11.

Saw blade 16 is attached on a flange on saw arm 17 and is driven in sawing mode by drive motor 18 about rotation axis 19. In the basic position of saw arm 17, which is depicted in FIG. 2A, the pivot angle is 0° and rotation axis 19 of saw blade 16 lies in depth direction 52 above pivot axis 23. Saw blade 16 is moved out of the basic position at 0° into workpiece 24 by a pivot motion of saw arm 17 about pivot axis 23. During the pivot motion of saw arm 17, saw blade 16 is driven by drive motor 18 about rotation axis 19.

To protect the operator, saw blade 16 is to be enclosed by blade guard 21 when in operation. Wall saw 12 is operated with blade guard 21 or without blade guard 21. To make the separating cut in the region of end points E₁, E₂, removal of blade guard 21 may be provided for example. If various saw blade diameters are used to make the separating cut, one generally also uses various blade guards with corresponding blade guard widths.

FIG. 2B depicts saw arm 17, which is tilted in a negative rotation direction 54 at a negative pivot angle −α. Saw arm 17 is adjustable in negative rotation direction 54 between pivot angles from 0° to −180° and in a positive rotation direction 55, oriented opposite negative rotation direction 54, between pivot angles 0° to +180°. The arrangement of saw arm 17 depicted in FIG. 2B is referred to as a pulling configuration when saw head 14 is moved in a positive feed direction 56. When saw head 14 moves in a negative feed direction 57, oriented opposite positive feed direction 56, the arrangement of saw arm 17 is referred to as a pushing configuration.

Given a pivot angle of ±180°, the maximum penetration depth of saw blade 16 into workpiece 24 is reached. By means of the pivot motion of saw arm 17 about pivot axis 23, the position of rotation axis 19 is shifted in direction X and direction Y. The shift of rotation axis 19 is thereby dependent on saw arm length δ and pivot angle α of saw arm 17. The displacement distance δₓ in direction X amounts to δ·sin(±α) and the displacement distance δ_{y} in direction Y amounts to δ·cos(±α).

In workpiece 24, saw blade 16 produces a cutting wedge in the form of a circular segment having a height h and a width b. Height h of the circular segment corresponds to the penetration depth of saw blade 16 in workpiece 24. For penetration depth h, equation D/2=h+Δ+δ·cos(α) applies, wherein D is the saw blade diameter, h is the penetration depth of saw blade 16, A is the perpendicular distance between pivot axis 23 and top side 53 of workpiece 24, δ is the saw arm length, and α is the first pivot angle; for width b, the equation b²=D/2·8h−4h²=4Dh−4h²=4h·(D−h), wherein h is the penetration depth of saw blade 16 in workpiece 24 and D is the saw blade diameter.

Controlling wall saw 12 during the separating cut depends on whether the end points are defined as obstacles, and for an obstacle, whether cutting occurs with blade guard 21 or without blade guard 21. For a free end point without an obstacle, controlling wall saw 12 in the method according to the invention occurs by means of upper exit points of saw blade 16 on top side 53 of workpiece 24. The upper exit points of saw blade 16 can be calculated from reference position X_{Ref} of pivot axis 23 in direction X, displacement path δₓ of rotation axis 19 in direction X, and width b. An upper exit point facing first end point E₁ is referred to as first upper exit point 58 and an upper exit point facing second end point E₂ is referred to as second upper exit point 59. For first upper exit point 58, X(58)=X_{Ref} +δₓ−b/2 applies, and for second upper exit point 59, X(59)=X_{Ref} +δₓ+b/2 applies where b=√[h (D−h)] and h=h(α, D).

If end points E₁, E₂ are defined as obstacles, overrunning end points E₁, E₂ with wall saw 12 is not possible. In this case, wall saw 12 in the method according to the invention is controlled via reference position X_{Ref} of pivot axis 23 and the boundary of wall saw 12. One thereby differentiates between processing without blade guard 21 and processing with blade guard 21.

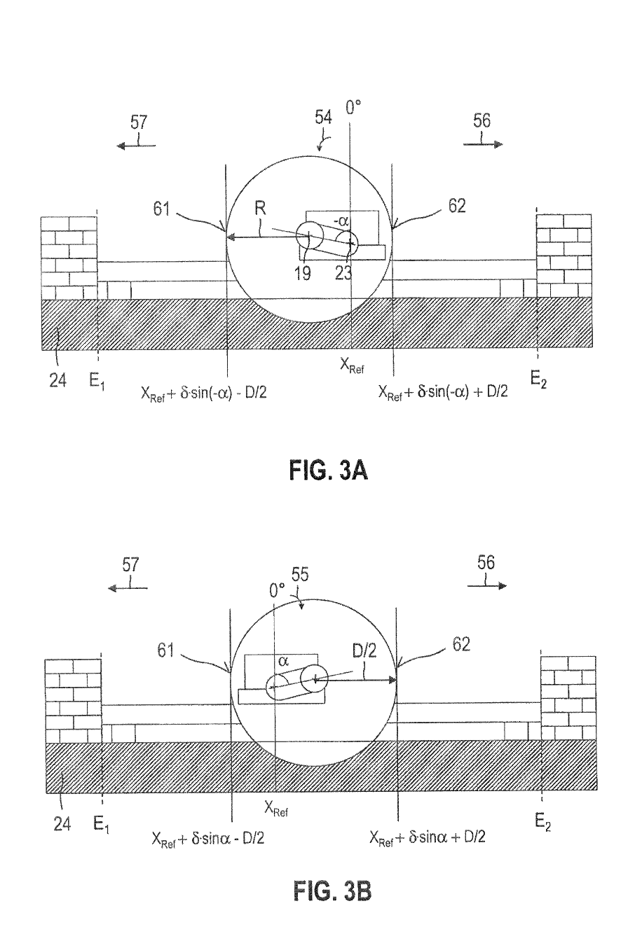

FIGS. 3A, B depict wall saw system 10 when making a separating cut between first end point E₁ and second end point E₂, which are defined as obstacles, wherein the cutting occurs without blade guard 21. When cutting without blade guard 21, a first saw blade edge 61, which faces first end point E₁, and a second saw blade edge 62, which faces second end point E₂, form the boundary of wall saw 12.

The X-positions of the first and second saw blade edge 61, 62 in direction X can be calculated from reference position X_{Ref} of pivot axis 23, displacement distance δₓ of rotation axis 19 and saw blade diameter D. FIG. 3A depicts wall saw 12 with saw arm 17 tilted in negative rotation direction 54 at a negative pivot angle −α (0° to −180°). For first saw blade edge 61, X(61)=X_{Ref}+δ·sin(−α)−D/2 applies and for the second saw blade edge 62, X(61)=X_{Ref}+δ·sin(−α)+D/2 applies. FIG. 3B depicts wall saw 12 with saw arm 17 tilted in positive rotation direction 55 at a positive pivot angle α (0° to +180°. For first saw blade edge 61, X(61)=X_{Ref}+δ·sin(α)−D/2 applies and for the second saw blade edge 62, X(62)=X_{Ref}+δ·sin(α)+D/2 applies.

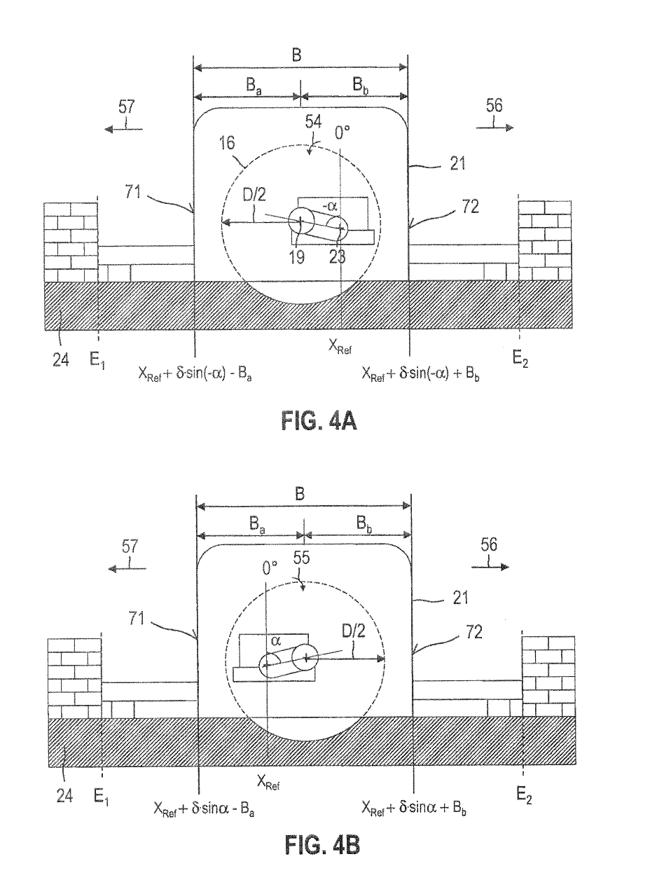

FIGS. 4A, B depict wall saw system 10 when making a separating cut between first end point E₁ and second end point E₂, which are defined as obstacles, wherein the cutting occurs with blade guard 21. When cutting without blade guard 21, the boundary of wall saw 12 is formed by a first blade guard edge 71, which faces first end point E₁, and a second blade guard edge 72, which faces second end point E₂.

The X-positions of the first and second blade guard edge 71, 72 in direction X can be calculated from reference position X_{Ref} of pivot axis 23, displacement distance δₓ of rotation axis 19 and blade guard width B. FIG. 4A depicts wall saw 12 with saw arm 17 inclined at a negative pivot angle −α (0° to −180°) and installed blade guard 21 having blade guard width B. Given an asymmetrical blade guard and before the start of the controlled processing, the distances of rotation axis 19 to blade guard edges 71, 72 are determined, wherein the distance to first blade guard edge 71 is referred to as first distance Bₐ and the distance to second blade guard edge 72 is referred to as second distance B_{b}.

For first blade guard edge 71, X(71)=X_{Ref}+δ sin(α)−Bₐ applies, and for the second blade guard edge 72, X(72)=X_{Ref}+δ sin(α)+B_{b} applies. FIG. 4B depicts wall saw 12 with saw head 17 tilted at a positive pivot angle α (0° to +180°) and installed blade guard 21 having blade guard width B. For first blade guard edge 71, X(71)=X_{Ref} +δsin(α)−Bₐ applies, and for the second blade guard edge 72, X(72)=X_{Ref} +δsin(α)+B_{b} applies.

FIGS. 2A, B depict a separating cut between two end points E₁, E₂ that are defined as free end points without obstacles, and FIGS. 3A, B and 4A, B depict a separating cut between two end points E_{1,} E₂ that are defined as obstacles. In actual practice, separating cuts are also possible in which one end point is defined as an obstacle and the other end point represents an end point without an obstacle, wherein the control of the wall saw for the free end point occurs via the upper exit point of the saw blade and for the obstacle via the saw blade edge (cutting without blade guard 21) or the blade guard edge (cutting with blade guard 21).

First upper exit point 58, first saw blade edge 61 and first blade guard edge 71 are combined under the term “first boundary” of wall saw 12 and the second upper exit point 59, second saw blade edge 62 and second blade guard edge 72 are combined under the term “second boundary.”

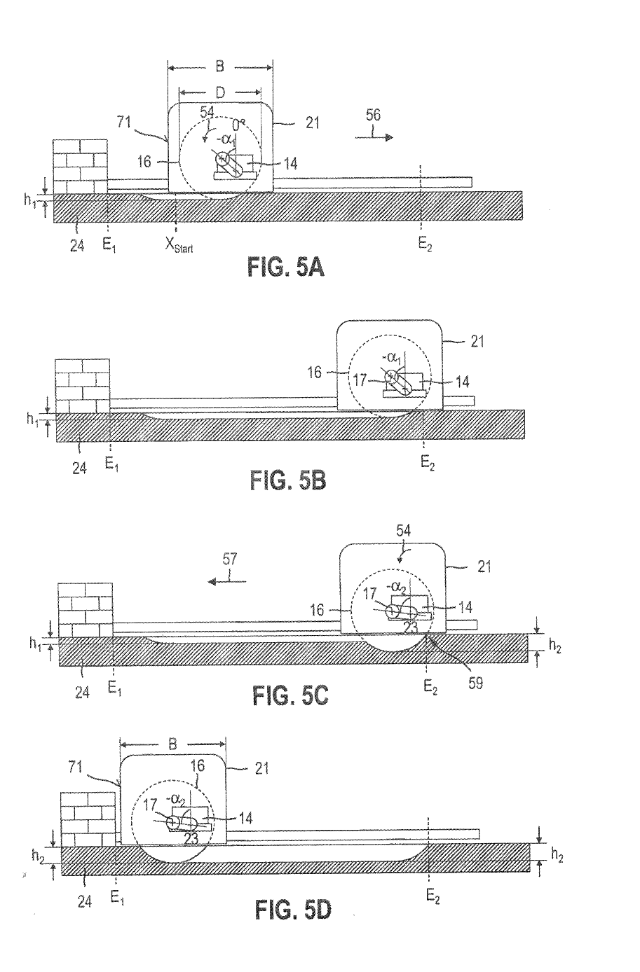

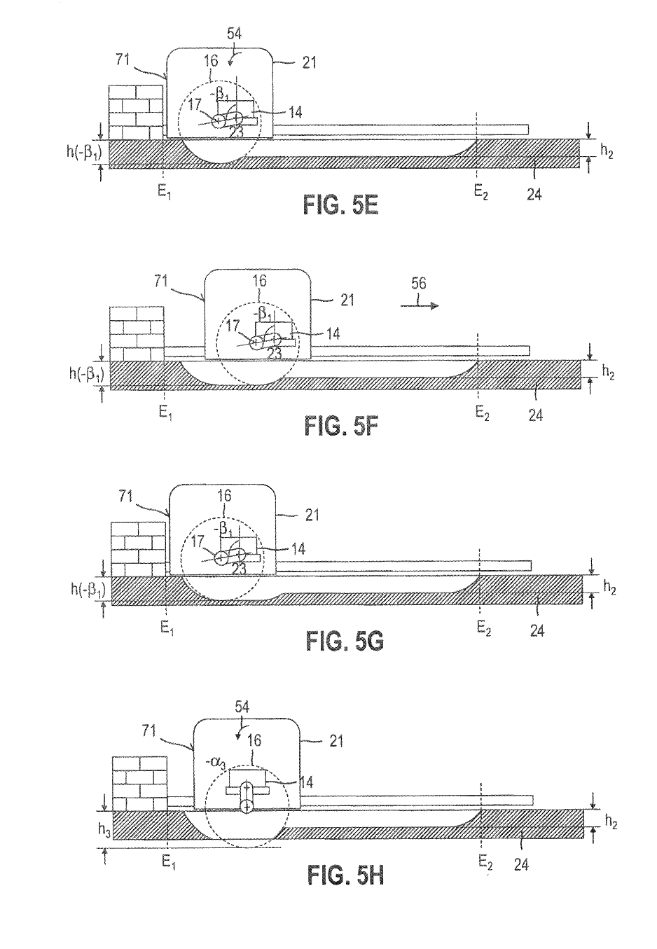

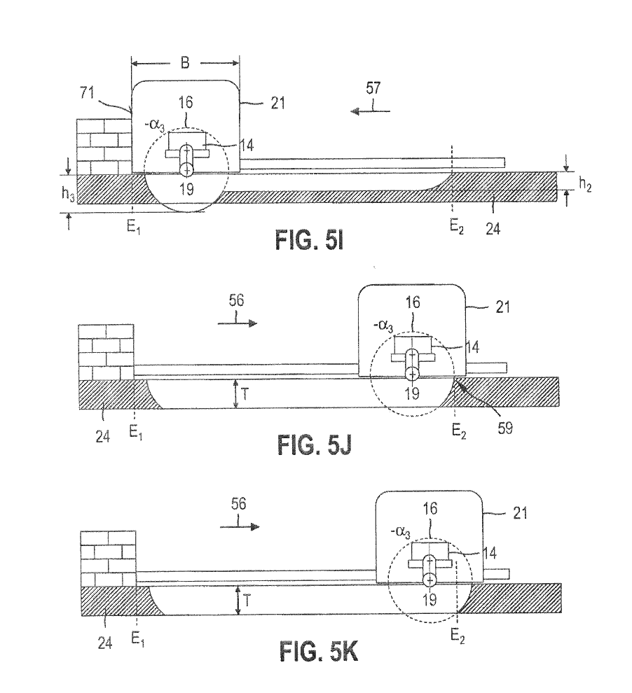

FIGS. 5A-K depicts wall saw system 10 of FIG. 1 with guide track 11 and wall saw 12 when making a separating cut having end depth T in workpiece 24 between a first end point E₁, which represents an obstacle, and a second end point E₂, which represent a free end point without an obstacle.

Performing the separating cut occurs using the method according to the invention for controlling a wall saw system. The separating cut is made in a main cutting sequence of multiple main cuts until the desired end depth T is reached. The main cutting sequence comprises a first main cut having a first main cutting angle α₁ of saw arm 17, a first diameter D₁ and a first penetration depth h₁ of the utilized saw blade, a second main cut having a second main cutting angle α₂ of saw arm 17, a second diameter D₂ and a second penetration depth h₂ of the utilized saw blade, as well as third main cut having a third main cutting angle α₃ of saw arm 17, a third diameter D₃ and a third penetration depth h₃ of the utilized saw blade.

In the embodiment, the first, second, and third main cuts are performed by saw blade 16 having saw blade diameter D and by blade guard 21 having blade guard width B. Diameters D₁, D₂, D₃ of main cuts correspond to saw blade diameter D of saw blade 16; likewise widths B₁, B₂, B₃ of the main cut correspond to blade guard width B of blade guard 21.

In the method according to the invention, the main cuts are performed with a saw arm 17, which is arranged in an alternating pulling and pushing manner. The pulling configuration of saw arm 17 allows a stable guiding of the saw blade while cutting and a small cut gap. A separating cut, in which saw arm 17 is arranged in an alternating pulling and pushing manner, has the advantage that the necessary non-productive times for positioning saw head 14 and pivoting saw arm 17 are reduced compared to cutting with a saw arm 17 configured solely in a pulling manner. In the embodiment, saw head 14 is moved in the first and third main cuts with saw arm 17 in a pulling configuration in positive feed direction 56; in the intermediate second main cut, saw head 14 is moved with saw arm 17 in a pushing configuration in negative feed direction 57. In the three main cuts, saw arm 17 is arranged in negative rotation direction 54 in each case.

Performing the separating cut begins at first end point E₁. After starting the method according to the invention, saw head 14 is positioned in a start position X_{Start}, in which pivot axis 23 has a distance of √[h₁·(D₁−h₁)]−δ·sin(−α₁) to first end point E₁, wherein h₁=D₁)=D₁/2−Δ−δ·cos(−α₁) refers to the penetration depth of the utilized saw blade in workpiece 24 for a negative first main cutting angle −α₁ having first diameter D₁ corresponding to saw blade diameter D. In start position Xₛₜₐᵣₜ, saw arm 17 is pivoted out of the basic position at 0° in negative rotation direction 54 into negative first cutting angle −α. After the pivot motion into negative first cutting angle −α, first blade guard edge 71 of blade guard 21 abuts the obstacle at first end point E₁. Subsequently, saw head 14 with saw arm 17, tilted at negative first cutting angle −α₁, and rotating saw blade 16 are moved into positive feed direction 56 (FIG. 5A). During the feed motion, the position of saw head 14 is measured on a regular basis by displacement sensor 33.

The feed motion of saw head 14 is stopped when pivot axis 23 has a distance to second end point E₂ of √[h₂·(D₂−h₂)]+δ·sin(−α₂), wherein h₂=h(−α₂, D₂)=D₂/2−Δ−δ·cos(−α₂) refers to the penetration depth of the utilized saw blade in workpiece 24 given a negative second main angle −α₂ with second diameter D₂, which corresponds to saw blade diameter D (FIG. 5B). In this position, saw arm 17 is pivoted out of the negative first main cutting angle −α₁ into the negative second main cutting angle −α₂ (FIG. 5C). In the positioning in FIG. 5B, the distance is adjusted in such a manner that second upper exit point 59, facing second end point E₂, of saw blade 16 coincides with second end point E₂ after the pivot motion of saw arm 17 into negative second main cutting angle −α₂.

Saw head 14 is moved in negative feed direction 57 to first end point E₁, wherein the position of saw head 14 is measured on a regular basis during the feed motion by displacement sensor 33 (FIG. 5D). In the embodiment, the pivot motion of saw arm 17 from negative second main cutting angle −α₂ into negative third main cutting angle −α₃ occurs in two steps with a first intermediate angle −β₁. The breakdown of the pivot motion into at least two steps reduces the risk that a polishing of saw blade 16 occurs. A smaller pivot angle results in reducing the arc length of the saw blade that is engaged with the workpiece.

The feed motion of saw head 14 in the second main cut in FIG. 5D is stopped when pivot axis 23 has a distance of B/2−δ·sin(−β₁) to the first end point E₁ when the first intermediate angle −β₁ is less than −90° Since the pivot motion occurs at obstacle E₁ and the first interim angle −β₁ is larger than −90° in the embodiment, it is not possible to position saw head 14 in such a manner that second blade guard edge 72 abuts obstacle E₁ after the pivot motion into first intermediate angle −β₁. The positioning of saw head 14 occurs by means of critical angle αₖᵣᵢₜ of −90° and saw arm 17 is then pivoted into first intermediate angle −β₁ (FIG. 5E). At critical angle αₖᵣᵢₜ of −90°, pivot axis 23 has a distance of B.2/2−δ·sin(−90°)=B.2/2+δ to first end point E₁. The critical angle of −90° must be taken into account since the first end point E1 may not be exceeded in the pivot motion.

In the embodiment, the pivot motion was executed from negative first main cutting angle −α₁ to negative second main cutting angle −α₂ in one step and the pivot motion from negative main cutting angle −α₂ to negative third main cutting angle −α₃ in two steps; alternatively, the pivot motion to the negative second main cutting angle −α₂ can occur in multiple steps or the pivot motion to negative third main cutting angle −α₃ can occur in one step. The decision regarding how many steps are required depends among other things on the specification of the saw blade, the hardness of the material, as well as the power and torque of the drive motor for the saw blade. The intermediate angles may be established by the operator or the intermediate angles may be established by the control unit of the wall saw system depending on various boundary conditions. For the method according to the invention, the main cutting angles of the main cuts and possible intermediate angles represent one input variable that is used to control the wall saw.

After the pivot motion of saw arm 17 into first intermediate angle −β₁, a free-cutting of saw blade 16 occurs. To do so, saw head 14 with saw arm 17, tilted at first intermediate angle −β₁, and rotating saw blade 16 is moved in positive feed direction 56 about a path distance of √[h₃·(D₃−h₃) (FIG. 5F), wherein h₃=h(−α₃, D₃)=D₃/2−Δ−δ·cos(−180°)=D₃/2−Δ+δ corresponds to the penetration depth of saw blade 16 in workpiece 24 given negative third main cutting angle −α₃ with third diameter D₃, which corresponds to saw blade diameter D. After the free-cutting, saw head 14 is positioned by means of critical angle −αₖᵣᵢₜ of −90° (FIG. 5G) and saw arm 17 is then pivoted out of first intermediate angle −β₁ into negative main cutting angle −α₃ (FIG. 5H).

Since the third main cut represents the last main cut of the cutting sequence, there occurs prior to performing the last main cut, a corner-cutting of first end point E₁. To do so, saw head 14 is moved in negative feed direction 57 with the saw arm 17 tilted at −α₃ until pivot axis 23 has a distance to first end point E₁ and first blade guard edge 71 of blade guard 21 abuts the obstacle at first end point E₁ (FIG. 5I). Corner-cutting of first end point E₁ can be improved if blade guard 21 is removed and corner-cutting occurs without a blade guard. Without a blade guard, saw head 14 is moved in negative feed direction 57 with saw arm 17 tilted at −α₃ until first saw blade edge 61 of saw blade 16 coincides with first end point E₁.

For hard materials of workpiece 24 or low-power drive motors 18, corner-cutting at obstacle E₁ can also be performed in multiple steps with intermediate angles. In this case and after pivot motion to third main cutting angle −α₃, saw arm 17 is moved to a start position and in the start position it is pivoted into the first intermediate angle. With saw arm 17 tilted at the first intermediate angle, saw head 14 is moved in negative feed direction 57 until first blade guard edge 71 abuts obstacle E₁. Then, saw head 14 is moved back to the start position, saw arm 17 is pivoted into the next intermediate angle, and saw head 14 is moved in negative feed direction 57 with tilted saw arm 17 until first blade guard edge 71 abuts obstacle E₁. These method steps are repeated until saw head 14 with saw arm 17 tilted at third main cutting angle −α₃ is arranged in a position such that first blade guard edge 71 abuts obstacle E₁. Corner processing can also be performed in multiple intermediate steps without blade guard 21.

After corner-cutting first end point E₁, the third main cut is performed with saw arm 17 tilted at negative third main angle −α₃ in positive feed direction 56 (FIG. 5J). The feed direction of saw head 14 is stopped when pivot axis 23 has a distance of √[h₃·(D₃−h₃)]+δ·sin(−α₃) to second end point E₂, wherein h₃=h(−α₃, D₃)=D₃/2−Δ−δ·cos(−α₃) refers to the penetration depth of the saw blade in workpiece 24 given a negative third main cutting angle −α₃ with third diameter D₃, which corresponds to saw blade diameter D.

If an overcut is allowed at second end point E₂, corner-cutting of second end point E₂ occurs after the third main cut (FIG. 5K). For hard materials of workpiece 24 or low-power drive motors 18, corner-cutting at second end point E₂ can also be performed in multiple steps with intermediate angles. In this case, saw arm 17 is moved into a start position after the end of the third main cut and, in the start position, it is pivoted into the first intermediate angle. The start position is calculated in such a manner that the pivot motion occurs in all intermediate angles of corner-cutting prior to the second end point E₂ and the second end point E₂ is not exceeded. With saw arm 17 tilted at the first intermediate angle, saw head 14 is moved in positive feed direction 56 until second upper exit point 59 of saw blade 16 has reached an end position, wherein second upper end point 59 in the end position has a distance to second end point E₂ of √[h₃·(D₃−h₃))−√[Δh·(D−Δh)]. Δh=h₃—T thereby refers to the difference between penetration depth h₃ and end depth T, and h₃=h(−α₃, D)=D/2−Δ−δ·cos(−α₃) refers to the penetration depth of saw blade 16 in workpiece 24 given a negative third pivot angle −α₃. Then, saw head 14 is placed back in the start position, saw arm 17 is pivoted into the next intermediate angle, and saw head 14 with tilted saw arm 17 is moved in positive feed direction 56 into the end position. These method steps are repeated until saw head 14 with saw arm 17 tilted at negative third main cutting angle −α₃ is arranged in the end position.

1.-23. (canceled)

24. A method for controlling a wall saw system, wherein the wall saw system comprises a guide track and a wall saw with a saw head, a motorized feed unit that displaces the saw head parallel to a feed direction along the guide track, at least one saw blade that is attached to a saw arm which is pivotable about a pivot axis of the saw head and is driven about a rotation axis, and at least one removable blade guard enclosing the saw blade;
and comprising the steps of:
making a separating cut of an end depth (T) in a workpiece having a workpiece thickness (d) between a first end point (E₁) and a second end point (E₂);
wherein prior to starting a processing of the separating cut, controlled by a control unit of the wall saw, at least a saw blade diameter (D) of the at least one saw blade, positions of the first and second end points in the feed direction, the end depth (T) of the separating cut, and a main cutting sequence of main cuts are determined;
wherein the main cutting sequence comprises at least a first main cut having a first main cutting angle (α₁) of the saw arm and a first diameter (D₁) of the utilized saw blade in the first main cut and a subsequent second main cut with a second main cutting angle (α₂) of the saw arm and a second diameter (D₂) of the utilized saw blade in the second main cut;
wherein during the processing controlled by the control unit:
the saw arm is arranged in a negative rotation direction at a negative first main cutting angle (−α₁); and
the saw head is moved in a positive feed direction in a direction of the second end point (E₂), wherein the saw arm is in a pulling configuration;
wherein the saw head is moved during the processing controlled by the control unit in such a manner that after a pivot motion of the saw arm into a negative second main cutting angle, a second boundary facing the second end point (E₂) of the wall saw coincides with the second end point (E₂), wherein the second boundary of the wall saw is formed by a second upper exit point, facing the second end point (E₂), of the utilized saw blade at a top side of the workpiece when the second end point (E₂) represents a free end point without an obstacle, by a second saw blade edge, facing the second end point (E₂), of the utilized saw blade when the second end point (E₂) represents an obstacle and the cutting occurs without a blade guard, and by a second blade guard edge, facing the second end point (E₂), of the utilized blade guard when the second end point (E₂) represents an obstacle and cutting occurs with a blade guard.

25. The method according to claim 24, wherein prior to starting the processing controlled by the control unit, a saw arm length (δ) of the saw arm, which is defined as a distance between the pivot axis and the rotation axis, and a distance (Δ) between the pivot axis and the top side of the workpiece are also determined.

26. The method according to claim 25, wherein prior to starting the controlled processing, a first width (B₁) is established for a blade guard utilized in a first main cut and a second width (B₂) for a blade guard utilized in the second main cut, wherein the first and second widths (B₁, B₂) are each composed of a first distance (B₁ₐ, B₂ₐ) of the rotation axis to the first blade guard edge and a second distance (B_{1b}, B_{2b}) of the rotation axis to the second blade guard edge.

27. The method according to claim 25, wherein after the pivot motion of the saw arm in the negative second main cutting angle (−α₂), the second upper exit point of the utilized saw blade coincides with the second end point (E₂), when the pivot axis has a distance to the second end point (E₂) of √[h₂·(D₂−h₂)]+δ·sin(−α₂), wherein h₂=h(−α₂, D₂)=D₂/2−Δ−δ·cos(−α₂) refers to a penetration of the utilized saw blade into the workpiece given a negative second main cutting angle (−α₂) with second diameter (D₂), the second saw blade edge of the utilized saw blade coincides with the second end point (E₂) when the pivot axis has a distance to the second end point (E₂) of D₂/2+δ·sin(−α₂), and the second blade guard edge of the utilized blade guard coincides with the second end point (E₂) when the pivot axis has a distance to the second end point (E₂) of B_{2b})+δ·sin(−α₂).

28. The method according to claim 24, wherein the second main cut represents a last main cut and the wall saw is moved into an end position.

29. The method according to claim 28, wherein the saw head is moved in such a manner that a first boundary, facing the first end point (E₁), of the wall saw coincides with the first end point (E₁), wherein the first boundary of the wall saw is formed on the top side of the workpiece by a first upper exit point, facing the first end point (E₁), of the utilized saw blade when the first end point (E₁) represents a free end point without an obstacle, by a first saw blade edge, facing the first end point (E₁), of the utilized saw blade when the first end point (E₁) represents an obstacle and the cutting occurs without a blade guard, and by a first blade guard edge, facing the first end point (E₁), of the utilized blade guard when the first end point (E₁) represents an obstacle and cutting occurs with a blade guard.

30. The method according to claim 29, wherein the first upper exit point of the utilized saw blade coincides with the first end point (E₁) when the pivot axis has a distance to the first end point (E₁) of √[h₂·(D₂−h₂)]−δ·sin(−α₂), wherein h₂=h(−α₂, D₂)=D₂/2−Δ−δ·cos(−α₂) represents the penetration depth of the utilized saw blade into the workpiece given a negative second main cutting angle (−α₂) with the second diameter (D₂), the first saw blade edge of the utilized saw blade coincides with the first end point (E₁) when the pivot axis has a distance to the first end point (E₁) of D₂/2−δ·sin(−α₂), and the first blade guard edge of the utilized blade guard coincides with the first end point (E₁) when the pivot axis has a distance to the first end point (E₁) of B₂ₐ−δ·sin(−α₂).

31. The method according to claim 24, wherein the main cutting sequence has a third main cut, following the second main cut, having a third main cutting angle (α₃) of the saw arm, a third diameter (D₃) of the utilized saw blade, and a third width (B₃) of the utilized blade guard with a first and a second distance (B₃ₐ, B_{3b}) to the blade guard edges, wherein the saw arm is arranged in a pulling configuration in the third main cut and the saw head is moved in the positive feed direction.

32. The method according to claim 31, wherein the saw head is moved during the processing controlled by control unit in such a manner that after the pivot motion of the saw arm into the negative third main cutting angle (−α₃), the first boundary of the wall saw coincides with the first end point (E₁), wherein the first boundary is formed by the first upper exit point of the utilized saw blade when the first end point (E₁) represents a free end point without an obstacle, by the first saw blade edge of the utilized saw blade when the first end point (E₁) represents an obstacle and the cutting occurs without a blade guard, and by the first blade guard edge of the utilized blade guard when the first end point (E₁) represents an obstacle and the cutting occurs with a blade guard.

33. The method according to claim 32, wherein the first upper exit point of the utilized saw blade coincides with the first end point (E₁) when the pivot axis has a distance to the first end point (E₁) of √[h₃·(D₃−h₃)]−δ·sin(−α₃), wherein h₃=h(−α₃, D₃)=D₃/2−Δ−δ·cos(−α₃) represents the penetration depth of the utilized saw blade into the workpiece given a negative third main cutting angle (−α₃) with the third diameter (D₃), the first saw blade edge of the utilized saw blade coincides with the first end point (E₁) when the pivot axis has a distance to the first end point (E₁) of D₃/2−δ·sin(−α₃), and the first blade guard edge of the utilized blade guard coincides with the first end point (E₁) when the pivot axis has a distance to the first end point (E₁) of B₃ₐ−δ·sin(−α₃).

34. The method according to claim 24, wherein the first and the second main cuts are made with one saw blade and one blade guard.

35. The method according to claim 24, wherein the first main cut is made by a first main saw blade and a first main blade guard, wherein the first saw blade has a first saw blade diameter (D.1) and the first blade guard has a blade guard width (B.1), and the second main cut is made with a second saw blade and a second blade guard, wherein the second saw blade has a second saw blade diameter and the second blade guard has a second blade guard width (B.2).

36. The method according to claim 24, wherein the first main cut of the main cutting sequence represents a precut and the saw head is positioned parallel to the feed direction into a start position (X_{Start}) after starting the processing controlled by the control unit, wherein in the start position (X_{Start}), the first boundary, facing the first end point (E₁), of the wall saw coincides with the first end point (E₁) after the pivot motion into the negative first main cutting angle (−α₁), wherein the first boundary is formed by the first upper exit point of the utilized saw blade when the first end point (E₁) represents a free end point without an obstacle, by the first saw blade edge of the utilized saw blade when the first end point (E₁) represents an obstacle and the cutting occurs without a blade guard, and by the first blade guard edge of the utilized blade guard when the first end point (E₁) represents an obstacle and the cutting occurs with a blade guard.

37. The method according to claim 36, wherein in the start position (X_{Start}), the first upper exit point of the utilized saw blade coincides with the first end point (E₁) when the pivot axis has a distance to the first end point (E₁) of √[h₁·(D₁−h₁)]−δ·sin(−α₁), wherein h₁=h(−α₁, D₁)=D₁/2−Δ−δ·cos(−α₁) represents the penetration depth of the utilized saw blade into the workpiece given a negative first main cutting angle (−α₁) with the first diameter (D₁), the first saw blade edge of the utilized saw blade coincides with the first end point (E₁) when the pivot axis has a distance to the first end point (E₁) of D₁/2−δ·sin(−α₁), and the first blade guard edge of the utilized blade guard coincides with the first end point (E₁) when the pivot axis has a distance to the first end point (E₁) of B₁ₐ−δ·sin(−α₁).

38. The method according to claim 24, wherein the main cutting sequence comprises a precut made prior to the first main cut having a zeroed main cutting angle (α₀) of the saw arm, a zeroed diameter (D₀) and a zeroed width (B₀) with a first and a second distance (B₀ₐ, B_{0b}) to the blade guard edges, wherein the saw arm is arranged in a pulling configuration for the precut and the saw head is moved in the negative feed direction.

39. The method according to claim 38, wherein the saw head is positioned parallel to the feed direction for the precut into a start position (X_{Start}) after starting the processing controlled by the control unit, wherein in the start position (X_{Start}), the second boundary, facing the second end point (E₂), of the wall saw coincides with the second end point (E₂) after the pivot motion into the positive zeroed main cutting angle (+α₀).

40. The method according to claim 39, wherein after the pivot motion of the saw arm into the positive zeroed main cutting angle (+α₀), the second upper exit point of the utilized saw blade coincides with the second end point (E₂) when the pivot axis has a distance to the second end point (E₂) of √[h₀·(D₀−h₀)]+δ·sin(+α₀), wherein h₀=h(+α₀, D₀)=D₀/2−Δ−δ·cos (+α₀) represents the penetration depth of the utilized saw blade into the workpiece given a positive zeroed main cutting angle (+α₀) with the zeroed diameter (D₀), the second saw blade edge of the utilized saw blade coincides with the second end point (E₂) when the pivot axis has a distance to the second end point (E₂) of D₀/2+δ·sin(+α₀), and the second blade guard edge of the utilized blade guard coincides with the second end point (E₂) when the pivot axis has a distance to the second end point (E₂) of B_{0b}+δ·sin(+α₀).

41. The method according to claim 40, wherein the saw head is stopped during controlled cutting in the positive feed direction when the first boundary of the wall saw coincides with the first end point (E₁), wherein the first boundary of the wall saw is formed by the first upper exit point of the utilized saw blade on the top side of the workpiece when the first end point (E₁) represents a free end point without an obstacle, by the first saw blade edge of the utilized saw blade when the first end point (E₁) represents an obstacle and the cutting occurs without a blade guard, and by a first blade guard edge of the utilized blade guard when the first end point (E₁) represents an obstacle and the cutting occurs with a blade guard.

42. The method according to claim 41, wherein the saw head is positioned in the positive feed direction in such a manner that the first boundary of the wall saw coincides with the first end point (E₁) after the pivot motion of the saw arm into negative first main cutting angle (−α₁), wherein the first upper exit point of the utilized saw blade coincides with the first end point (E₁) when the pivot axis has a distance to the first end point (E₁) of √[h₁·(D₁−h₁)]+δ·sin(−α₁), wherein h₁=h(−α₁, D₁)=D₁/2−Δ−δ·cos(−α₁) represents the penetration depth of the utilized saw blade into the workpiece given a negative first main cutting angle (−α₁) with the first diameter (D₁), the first saw blade edge of the utilized saw blade coincides with the first end point (E₁) when the pivot axis has a distance to the first end point (E₁) of D₁/2+δ·sin(−α₁), and the first blade guard edge of the utilized blade guard coincides with the first end point (E₁) when the pivot axis has a distance to the first end point (E₁) of B₁ₐ+δ·sin(−α₁).

43. The method according to claim 40, wherein the saw head is moved in such a manner that after the pivot motion of the saw arm in the negative zeroed main cutting angle (−α₀), the first boundary of the wall saw coincides with the first end point (E₁), wherein the first upper exit point of the utilized saw blade coincides with the first end point (E₁) when the pivot axis has a distance to the first end point (E₁) of √[h₀·(D₀−h₀)]−δ·sin(−α₀), wherein h₀=h(−α₀, D₀)=D₀/2−Δ−δ·cos(−α₀) represents the penetration depth of the utilized saw blade into the workpiece given a negative zeroed main cutting angle (−α₀) with the zeroed diameter (D₀), the first saw blade edge of the utilized saw blade coincides with the first end point (E₁) when the pivot axis has a distance to the first end point (E₁) of D₀/2−δ·sin(−α₀), and the first blade guard edge of the utilized blade guard coincides with the first end point (E₁) when the pivot axis has a distance to the first end point (E₁) of B₀ₐ−δ·sin(−α₀).

44. The method according to claim 43, wherein the saw head is moved in a positive feed direction by a displacement length of at least 2δ·|sin(−α₀)| and the saw head is then positioned in such a manner that the first boundary of the wall saw coincides with the first end point (E₁) after the pivot motion of the saw arm in the negative first main cutting angle (−α₁), wherein the first upper exit point of the utilized saw blade coincides with the first end point (E₁) when the pivot axis has a distance to the first end point (E₁) of √[h₁·(D₁−h₁)]−δ·sin(−α₁), wherein h₁=h(−α₁, D₁)=D₁/2−Δ−δ·cos(−α₁) represents the penetration depth of the utilized saw blade into the workpiece given a negative first main cutting angle (−α₁) with the first diameter (D₁), the first saw blade edge of the utilized saw blade coincides with the first end point (E₁) when the pivot axis has a distance to the first end point (E₁) of D₁/2−δ·sin(−α₁), and the first blade guard edge of the utilized blade guard coincides with the first end point (E₁) when the pivot axis has a distance to the first end point (E₁) of B₁ₐ−δ·sin(−α₁).

45. The method according to claim 43, wherein the saw head is moved in the positive feed direction in such a manner that the first boundary of the wall saw coincides with the first end point (E₁) after the pivot motion of the saw arm in the negative first main cutting angle (−α₁), wherein the first upper exit point of the utilized saw blade coincides with the first end point (E₁) when the pivot axis has a distance to the first end point (E₁) of √[h₁·(D₁−h₁)]−δ·sin(−α₁), wherein h₁=h(−α₁, D₁)=D₁/2−Δ−δ·cos(−α₁) represents the penetration depth of the utilized saw blade into the workpiece given a negative first main cutting angle (−α₁) with the first diameter (D₁), the first saw blade edge of the utilized saw blade coincides with the first end point (E₁) when the pivot axis has a distance to the first end point (E₁) of D₁/2−δ·sin(−α₁), and the first blade guard edge of the utilized blade guard coincides with the first end point (E₁) when the pivot axis has a distance to the first end point (E₁) of B₁ₐ−δ·sin(−α₁).

46. The method according to claim 41, wherein the saw head is moved in such a manner that, after the pivot motion of the saw arm in the negative first main cutting angle (−α₁), the first boundary of the wall saw coincides with the first end point (E₁), wherein the first upper exit point of the utilized saw blade coincides with the first end point (E₁), when the pivot axis has a distance in the feed direction to the first end point (E₁) of √[h₁·(D₁−h₁)]−δ·sin(−α₁), wherein hi =h(−α₁, D₁)=D₁/2−Δ−δ·cos(−α₁) represents the penetration depth of the utilized saw blade into the workpiece given a negative first main cutting angle (−α₁) with the first diameter (D₁), the first saw blade edge of the utilized saw blade coincides with the first end point (E₁) when the pivot axis has a distance to the first end point (E₁) of D₁/2−δ·sin(−α₁), and the first blade guard edge of the utilized blade guard coincides with the first end point (E₁) when the pivot axis has a distance to the first end point (E₁) of B₁ₐ−δ·sin(−α₁).
